(19) United States
(12) Patent Application Publication
(10) Pub. No.: US 2002/0157817 A1
(43) Pub. Date: Oct. 31, 2002

(54) Plastic heat exchanger

(75) Inventors: Alberto Mannoni, Torino (IT); Carlo Bella, Torino (IT); Giuseppe Bonaldo, Poirino (IT); Massimo Colonna, Vinovo (IT)

Correspondence Address: SUGHRUE MION, PLLC, 2100 PENNSYLVANIA AVENUE, N.W., WASHINGTON, DC, 20037, US

(73) Assignee: DENSO THERMAL SYSTEMS SPA

(21) Appl. No.: 10/102,771

(22) Filed: Mar. 22, 2002

(30) Foreign Application Priority Data
Apr. 27, 2001 (IT) TO2001A000401

(51) Int. Cl. F28F 9/02; F28F 9/04; B23P 15/26; B21D 39/06; B21D 53/02; B21D 53/04; B21D 53/06; B21D 53/08; B21D 51/38

(52) U.S. Cl. 165/173; 165/178; 29/890.039; 29/890.04; 29/890.052

(57) ABSTRACT

A heat exchanger (10) comprising a plurality of plastic tubes (12) arranged in a series of mutually parallel rows and a pair of plastic collector plates (14) bonded to the respective ends of the said tubes (12). Each collector plate (14) is formed by a plurality of plastic terminal elements (22), each of which has at least one set of semicircular seats (24 and 26) suitable for receiving the ends of a row of tubes (12). The said semicircular seats (24 and 26) of each terminal element (22) are separated from each other by bonding portions (28 and 30) suitable for welding to the corresponding bonding portions of a complementary terminal element along a welding plane (34). The bonding portions (28) of the first terminal element (22′) have butt surfaces (36) that are set back with respect to the said welding plane (34) while the bonding portions (30) of the second terminal element (22″) destined to be bonded to the first terminal element (22′) have welding portions (38) projecting across the said welding plane (34). The ratio (R) between the volume of the said welding portions (38) and the volume between the butt portions (36) and the said welding plane (34) is in the range 0.8 to 1.3.

The present invention relates to heat exchanger made of a plastic material according to the preamble of claim 1.

Heat exchangers for vehicles comprising a plurality of plastic tubes arranged in a series of mutually parallel rows and a pair of plastic collector plates connected to the ends of the tubes have already been proposed. With regards to the collector plates, the solutions that contemplate manufacturing the plates in a single piece are affected by two orders of problems:

stamping a high-precision plate with many holes (200-2000) of small diameter (hole diameters in the order of 1.5-5 mm), with consequent checks for shrinkage and deformation, whilst also avoiding the presence of moulding flash in the holes,

automatically inserting the ends of the tubes in the holes of the collector plates.

Solutions whereby each collector plate is constructed from a number of plastic terminal elements that are overlapped and welded together have already been proposed to overcome these drawbacks. Each terminal element has a series of semicircular seats separated from each other by bonding portions suitable for being welded to corresponding bonding portions of a complementary terminal element. The assembly procedure for this type of heat exchanger starts from a first pair of terminal elements, engaging the ends of a first row of tubes in the semicircular seats of the terminal elements, positioning a second pair of terminal elements above the first row of tubes and welding the bonding portions of the terminal elements together. This operational sequence is repeated a number of times in correspondence to the number of rows of tubes that form the finished heat exchanger. Adjacent terminal elements are bonded together via welding, ultrasonic for example, causing the bonding portions in reciprocal contact to melt together. This welding operation is extremely delicate and requires especially accurate calibration of the welding parameters. In particular, if too much material is fused, flash formed by the plastic material can enter the ends of the tubes and cause a perforation, which will result in heat exchange fluid leakage in the finished heat exchanger. On the other hand, if the space between the butting surfaces of the bonding portions of the terminal elements is not completely closed during welding, a hermetic seal between the ends of the tubes and collector plate is not achieved and, in this case as well, the finished heat exchanger will have heat exchange fluid leaks.

The objective of the present invention is to provide improvements that allow the aforesaid drawbacks to be overcome.

According to the present invention, this object is attained by a heat exchanger having the characteristics forming the subject of the claim.

The characteristics and advantages of this invention will become evident from the detailed description that follows, supplied merely as a non limitative example, and with reference to the attached drawings, where:

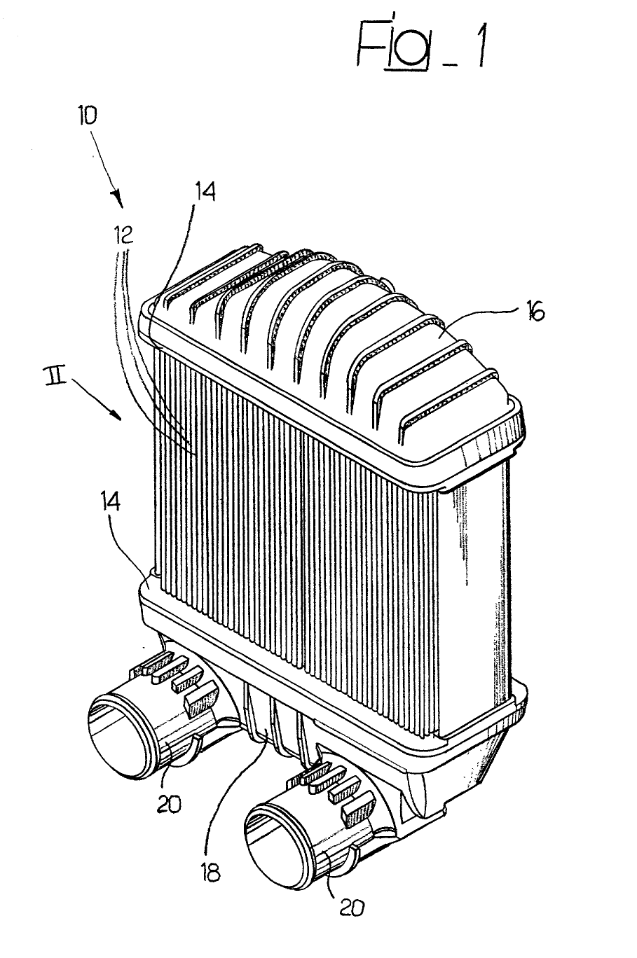

FIG. 1 is a perspective view illustrating a plastic heat exchanger in accordance with the present invention,

FIG. 2 is a perspective view of the heat exchanger group indicated by arrow II in FIG. 1,

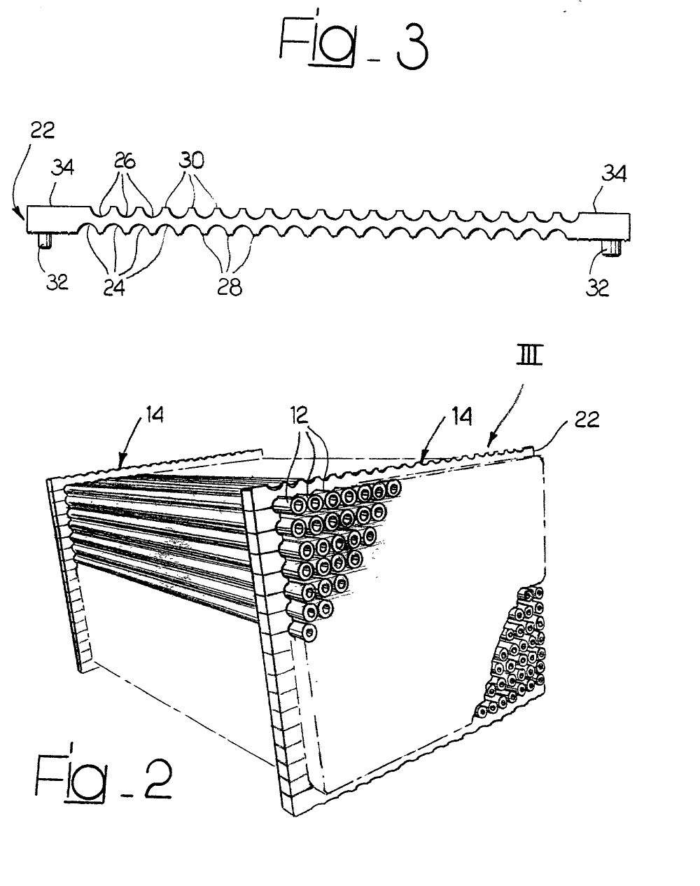

FIG. 3 is a front view of a terminal element indicated by arrow III in FIG. 2,

FIG. 4 is a schematic view illustrating the welding phase between two terminal elements,

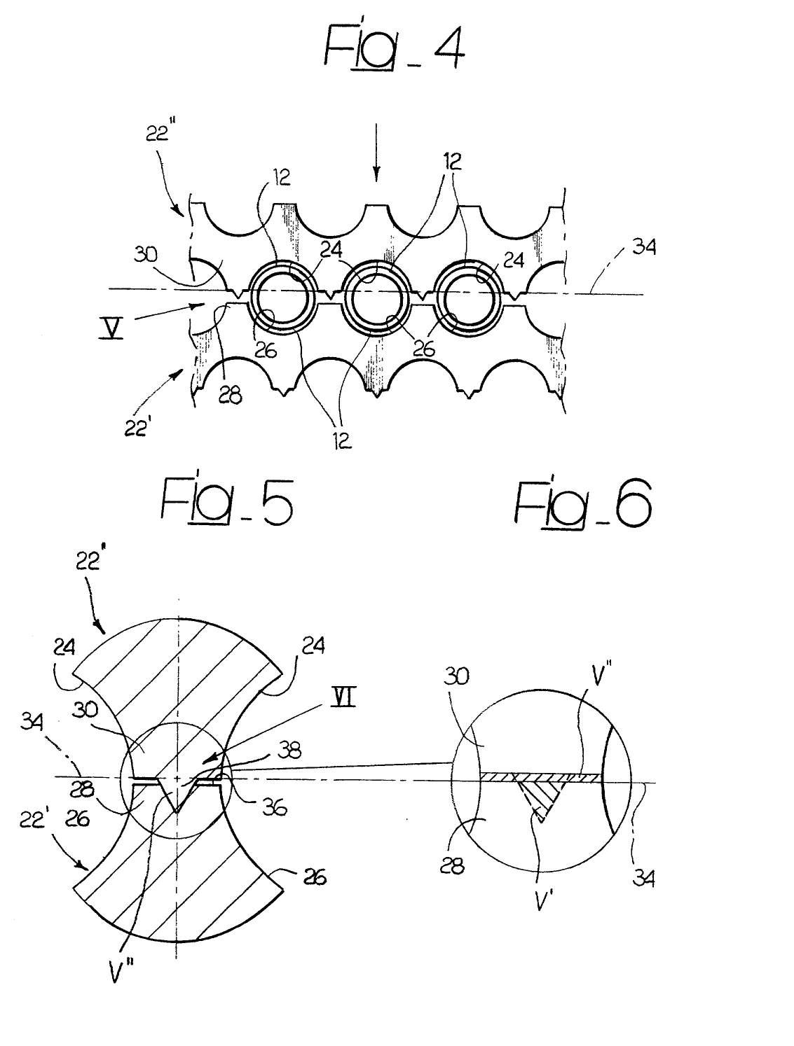

FIG. 5 shows an enlarged detail of the part indicated by arrow V in FIG. 4,

FIG. 6 is a schematic view illustrating the welding zone indicated by arrow VI in FIG. 5, and

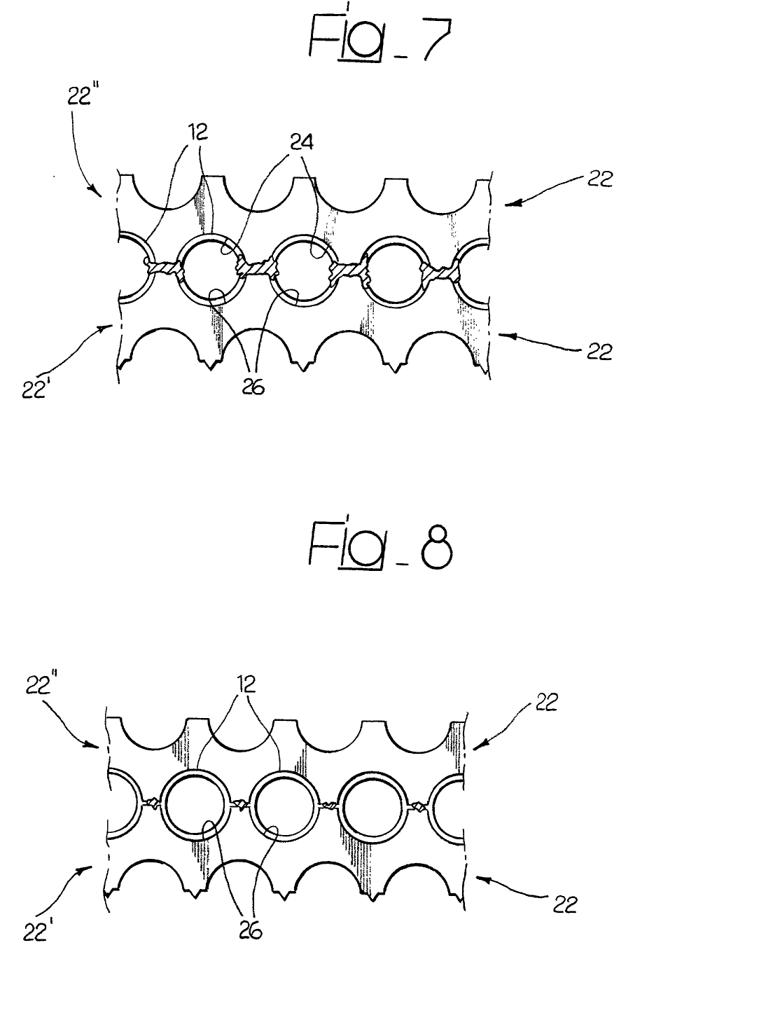

FIGS. 7 and 8 are schematic views, respectively illustrating the welding zones in conditions where there is excessive or insufficient welding material between the bonding portions of the terminal elements.

With reference to FIG. 1, item 10 indicates a heat exchanger for vehicles made entirely of plastic. The heat exchanger 10 comprises a heat exchange core including a number of tubes 12 formed of thin plastic straws arranged in a number of mutually parallel rows. The ends of the tubes are bonded and sealed to a pair of collector plates 14, realized in the manner that will be described further on. Two tanks 16 and 18 are bonded to the respective collector plates 14. One of the tanks 18 is equipped with openings 20 for the inlet and outlet of the heat exchange fluid.

With reference to FIGS. 2 and 3, each collector plate 14 is formed by a number of plastic terminal elements 22. Each terminal element 22 includes a first and a second row of semicircular seats 24 and 26, separated from each other by bonding portions 28 and 30. Each terminal element 22 is equipped with a pair of spacer elements 32 destined to rest against a surface 34 of an identical terminal element 22.

With reference to FIG. 4, the assembly of the heat exchanger core illustrated in FIG. 2 is carried out using single layers and each layer is realized via an operational sequence that contemplates:

preparing a first terminal element 22′,

placing the ends of a row of tubes 12 in the seats 26 of the first terminal element 22′,

offering up a second terminal element 22″ such that the ends of the tubes 12 engage with the seats 24 of the second terminal element 22″,

welding the bonding portions 28 and 30 of the bonding elements 22′ and 22″ together along the welding plane 34.

The welding is performed using a conventional ultrasonic welding device. The welding plane 34 represents an ideal joint plane that allows the semicircular seats 24 and 38 facing each other to be united together in order to form circular seats with a diameter equal to that of the external diameter of the ends of the tubes 12.

FIG. 5 shows a magnified view of two complementary bonding portions 28 and 30 that are destined to be bonded together via welding. FIG. 5 illustrates the position of the welding plane 34 with respect to the two terminal elements 22′ and 22″. Each bonding portion 28 of the terminal element 22′ has a butt surface 36 that is set back with respect to the welding plane 34. The volume between the welding plane 34 and the butt surfaces 36 of the terminal element 22′ is indicated by V′. Always with reference to FIG. 5, each bonding portion 30 of the terminal element 22″ has a welding portion 38 projecting beyond the welding plane 34. The volume of material of each bonding portion 30 projecting beyond the welding plane 34 is indicated by V″.

The fill ratio R is defined as the ratio between the volumes V′ and V″. According to the present invention, the fill ratio R is in the range 0.8 to 1.3:

R=V′/V″

0.8<R<1.3

FIG. 6 illustrates the bonding zone between the bonding portions 28 and 30 after welding is completed. The fact of having a fill ratio close to unity allows the volume V′ to be filled with material originating from the melting of volume V″. This permits an ideal bond between the terminal elements 22′ and 22″ to be achieved. In particular, the problems of excess molten material occluding the ends of the tubes or of zones that are not completely sealed due to an insufficient amount of molten material are avoided.

FIG. 7 illustrates the situation following a welding operation with a fill ratio that is too high, in excess of 1.3. In this case, the excess molten material exudes laterally from the reciprocal mating surfaces of the bonding portions and invades the spaces of the tubes. As is schematically illustrated in FIG. 7, the molten material may damage the walls of the tubes and cause heat exchange fluid leaks. FIG. 8 illustrates the opposite situation, where welding is carried out with a fill ratio that is too low, less than 0.8. In this case, the material that is welded is insufficient to fill the empty space between the butt surfaces of the bonding portions, giving rise to openings that can cause heat exchange fluid leaks via the collector plate.

Optimal bonding conditions are achieved with an fill ratio R in the range from 0.8 to 1.3, permitting optimal bonding between the terminal elements to be achieved whilst avoiding both of the problems schematized in FIGS. 7 and 8.

1. A heat exchanger (110), comprising a plurality of plastic tubes (12) arranged in a series of mutually parallel rows and a pair of plastic collector plates (14) bonded to the respective ends of the said tubes (12), each collector plate (14) being formed by a plurality of plastic terminal elements (22), each of which has at least one set of semicircular seats (24 and 26) suitable for receiving the ends of a row of tubes (12) and where the said semicircular seats (24 and 26) of each terminal element (22) are separated from each other by bonding portions (28 and 30) suitable for welding to the corresponding bonding portions of a complementary terminal element along a welding plane (34), characterized in that the said bonding portions (28) of a first terminal element (22′) have butt surfaces (36) that are set back with respect to the said welding plane (34), in that the bonding portions (30) of a second terminal element (22″) destined to be bonded to the first terminal element (22′) have welding portions (38) projecting across the said welding plane (34) and in that the ratio (R) between the volume of the said welding portions (38) and the volume between the said butt portions (36) and the said welding plane (34) is in the range 0.8 to 1.3
